(19) United States
(12) Patent Application Publication
(10) Pub. No.: US 2009/0206159 A1
(43) Pub. Date: Aug. 20, 2009

(54) Device and Method for Locating a Barcode Using Image Analysis

(76) Inventors: Alan J. Epshteyn, Miller Place, NY (US); David S. Koch, Islip, NY (US); Bradley Carlson, Huntington, NY (US)

Correspondence Address: MOTOROLA, INC., 1303 EAST ALGONQUIN ROAD, IL01/3RD, SCHAUMBURG, IL, 60196, US

(21) Appl. No.: 12/033,255

(22) Filed: Feb. 19, 2008

(51) Int. Cl. G06K 7/10

(52) U.S. Cl. 235/462.11

(57) ABSTRACT

A device comprises a memory and a processor. The memory stores an image. The image includes a plurality of areas. The image is captured using at least one of an auto-exposure technology and an auto-focus technology. The processor is coupled to the memory and selects at least one of the plurality of areas as a function of predetermined data. The data is related to the at least one of the auto-exposure technology and the auto-focus technology. The processor locates a symbol in the at least one selected areas.

### FIELD OF THE INVENTION

The present invention relates generally to a device and method for locating a barcode using image analysis. Specifically, an auto-focus algorithm and an auto-exposure algorithm are used on an area that includes a barcode so that a location of the barcode is ascertained.

### BACKGROUND

A packaging box may include at least one barcode. A data acquisition device may take an image of an area such as a side of the packaging box that includes one of the barcodes. Imaging technologies provide a means of locating a barcode in an image taken. In a first example, a center of the image is used as a starting point and an increasing coil pattern is used to locate any barcodes contained within the image. In a second example, the image may be segmented into several parts such as into quadrants. Each part is then analyzed to find any barcode located therein. The above described methods may be efficient if and only if the barcode is coincidentally located at a starting point for analysis. Because the methods are often performed using automated devices, the image may be random and sections of the packing box without a barcode may be analyzed. That is, the above described methods currently in use may be lengthy and inefficient, whether barcodes are located for a single packaging box or for multiple packaging boxes.

### SUMMARY OF THE INVENTION

The present invention relates to a device comprising a memory and a processor. The memory stores an image. The image includes a plurality of areas. The image is captured using at least one of an auto-exposure technology and an auto-focus technology. The processor is coupled to the memory and selects at least one of the plurality of areas as a function of predetermined data. The data is related to the at least one of the auto-exposure technology and the auto-focus technology. The processor locates a symbol in the at least one selected areas.

### DESCRIPTION OF THE DRAWINGS

FIG. 1 shows a mobile unit according to an exemplary embodiment of the present invention.

FIG. 2 shows a captured image to be analyzed according to an exemplary embodiment of the present invention.

FIG. 3 shows a method for locating a barcode using image analysis according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for locating a barcode using image analysis. In one exemplary embodiment, a mobile unit (MU) equipped with a data acquisition device where the data acquisition device may be used to locate a barcode using image analysis. In another exemplary embodiment, an image may be received for the image analysis to be performed. Specifically, an auto-focus algorithm and an auto-exposure algorithm are used to identify potential locations in which a barcode may be disposed. The MU, the data acquisition device, and the algorithms will be discussed in further detail below.

It should be noted that the following description of the exemplary embodiments illustrates a camera for the data acquisition device. The camera may represent any type of data acquisition device that may be equipped for image analysis. In addition, it should be noted that the following description of the exemplary embodiments illustrates an MU. However, the exemplary embodiments of the present invention may be applied to any computing device, whether mobile or not. Furthermore, it should be noted that the MU including the data acquisition device is only exemplary. The MU may not be equipped with the data acquisition device and, thus, the data acquisition device may be coupled with the MU. For example, the data acquisition device may be a module that is coupled externally to the MU. Finally, it should be noted that the use of barcodes is only exemplary. The barcode may represent any encoded data. Thus, the exemplary embodiments of the present invention may relate to scanning any form of image such as a one-dimensional barcode, a two-dimensional barcode, a color barcode, an optical character recognition (OCR) string, etc.

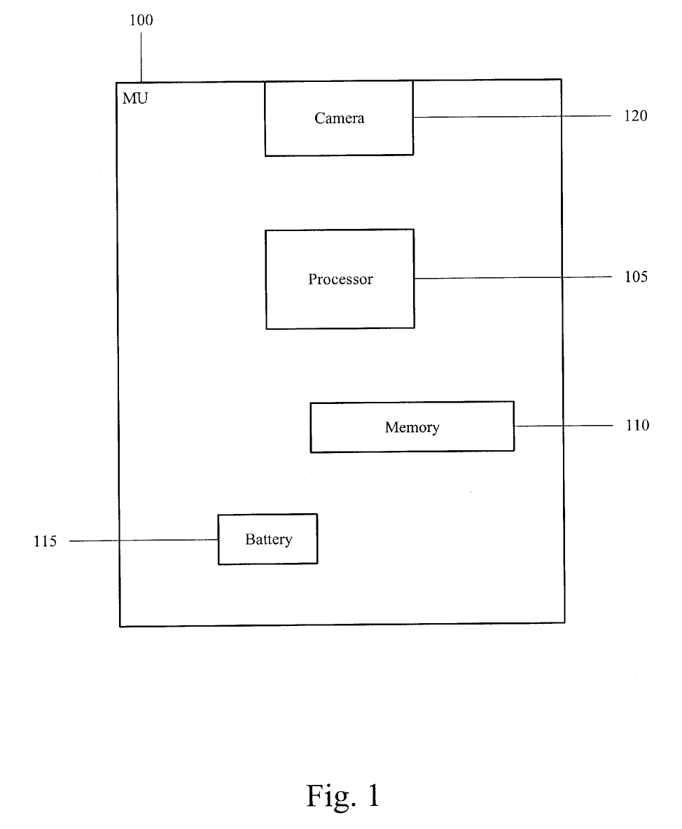

FIG. 1 shows a mobile unit (MU) 100 according to an exemplary embodiment of the present invention. The MU 100 may be any electronic device (e.g., portable or stationary) that utilizes a portable power supply (e.g., battery, capacitor, super capacitor, etc.). For example, the MU 100 may be a mobile computer, a personal digital assistant (PDA), a laptop, a pager, a cell phone, a radio frequency identification reader, a scanner, an image capturing device, etc. The MU 100 may include a processor 105, a memory 110, a battery 115, and a camera 120.

The processor 105 may be responsible for executing various functionalities of the MU 100. Specifically, according to the exemplary embodiments of the present invention, the processor 105 may be responsible for executing the auto-focus algorithm and the auto-exposure algorithm. As will be described in further detail below, the auto-focus algorithm and the auto-exposure algorithm may utilize data used to capture an image that may be in a buffer. The memory 110 may be a storage unit for the MU 100. Specifically, the memory 110 may store a captured image and/or the auto-focus algorithm and the auto-exposure algorithm. As will be explained in further detail below, the memory 110 may be used to store further data with each iteration of running the algorithms. The memory 100 may also store data and/or settings pertaining to various other functionalities of the MU 100. Furthermore, the memory 100 may store data related to a capturing of an image such as auto-exposure and/or auto-focus data. As discussed above, the MU 100 may include a portable power supply. As illustrated, the MU 100 may include the battery 115 to supply the necessary energy to operate the MU 100.

The camera 120 may be an image capturing device. Specifically, the camera 120 may be a conventional digital color camera. Thus, the camera 120 may include a lens, a shutter, an image sensor, etc. Light passing through the lens may be received and subsequently converted to corresponding digital signals that are used to recreate the image. Those skilled in the art will understand that the camera 120 is capable of capturing color images to duplicate an object, a scene, etc. in a condition at a moment of the capture. The camera 120 may also enable a continuous set of images to be captured in a finite time period. That is, the camera 120 may be configured to capture streaming images or a video. Any image captured by the camera 120 (e.g., single image, set of images, etc.) may be stored on the memory 110.

The camera 120 may also be equipped with auto-focus and auto-exposure technologies. According to the exemplary embodiments of the present invention, the auto-focus technology may enable high contrast edges to be located. The high contrast edges may be, for example, a change from a black area of a one- or two-dimensional barcode to a white area between adjacent black areas of the barcode. In another example, the high contrast edges may be a change from a first color of a color barcode to a second, adjacent color of a color barcode. The auto-exposure technology may enable continuous adjustments to be made on the exposure of an image until an optimal color balance is made for the image. The auto-focus technology may be used for the auto-focus algorithm while the auto-exposure technology may be used for the auto-exposure algorithm. The camera 120 may be equipped with an individual processor and memory to determine if an appropriate image is captured. That is, the camera 120 may continuously process images until the appropriate image is captured. Specifically, the appropriate image may be when a predefined clarity is obtained. The auto-focus technology and the auto-exposure technology may process the images to determine data in order to capture an image with the predefined clarity. The auto-focus and auto-exposure data for the image may be buffered in the memory 110 or the memory of the camera 120.

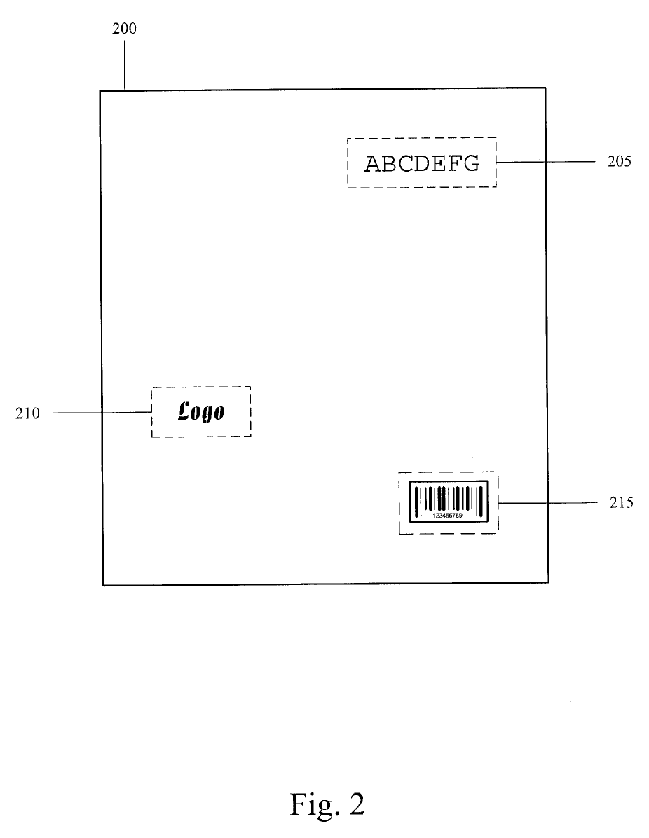

FIG. 2 shows an image 200 to be analyzed according to an exemplary embodiment of the present invention. The image 200 may be captured using the camera 120 of the MU 100. Specifically, the image 200 may be an image stored for analysis using the data stored in the buffer from using the auto-focus technology and the auto-exposure technology to result in the image 200. Because the camera 120 may be a digital color camera, the image 200 may be taken with colors or may be taken monochromatically as illustrated in FIG. 2. The image 200 may be of a panel of a packaging box in which various information may be displayed. However, it should be noted that the image 200 may be of any item in which a barcode is to be located.

The image 200 may include different types of information. For example, a logo, package content data, a barcode(s), etc. Areas not including the information may be a common color or shade such as a conventional brown found on cardboard boxes. Upon capturing the image 200, the image 200 may be analyzed by the processor 105. Specifically, the processor 105 utilizes the data from the auto-focus technology and the auto-exposure technology used to capture the image 200 by the camera 120. The data from the auto-focus technology and the auto-exposure technology may include, for example, histograms indicating variations in colors and/or shades. For example, the histograms may consider shades. The image 200 may be divided so that each piece of, for example, a grid is analyzed. Most of the pieces may exhibit a corresponding shade of the conventional brown shade of the cardboard box (when the image 200 is converted from a color image into a black and white image). However, areas that include potential data may exhibit other colors, in particular a black shade corresponding to, for example, the barcode. When histograms of each piece are analyzed, most of the histograms may only have a bar indicating the shade corresponding to the conventional brown shade. A histogram that has a bar indicating another shade may alert the processor that the corresponding piece includes potential data to be processed.

The image 200 may be segmented into a plurality of areas. Analyzing data generated from the auto-focus algorithm, high contrast edges may be found at locations 205, 210, and 215. In the location 205, package content data may be included. In the location 210, a logo may be included. In the location 215, a barcode may be included. However, because high contrast edges may be found in those locations, the auto-focus algorithm may indicate that a potential barcode may be disposed at any of the locations 205-215. A decoder algorithm may be run on the locations 205-215 to determine the actual existence of a barcode, thereby decreasing a total area the decoder algorithm would otherwise have to process. Thus, as illustrated, locations 205-210 may be discarded as not including barcodes while location 215 is indicated to include a barcode.

According to the exemplary embodiments of the present invention, by utilizing data from the auto-focus algorithm and the auto-exposure algorithm, a more efficient means of locating a barcode through image analysis may be had. Specifically, in contrast to being required to check an entire image for barcodes, specific locations may be ascertained so that analysis of those locations may indicate whether a barcode is located therein. Thus, empty spaces such as the areas of the image 200 that are not allocated to the locations 205-215 may be ignored. Therefore, an overall performance improvement of the barcode locating device such as the MU 100 may be had.

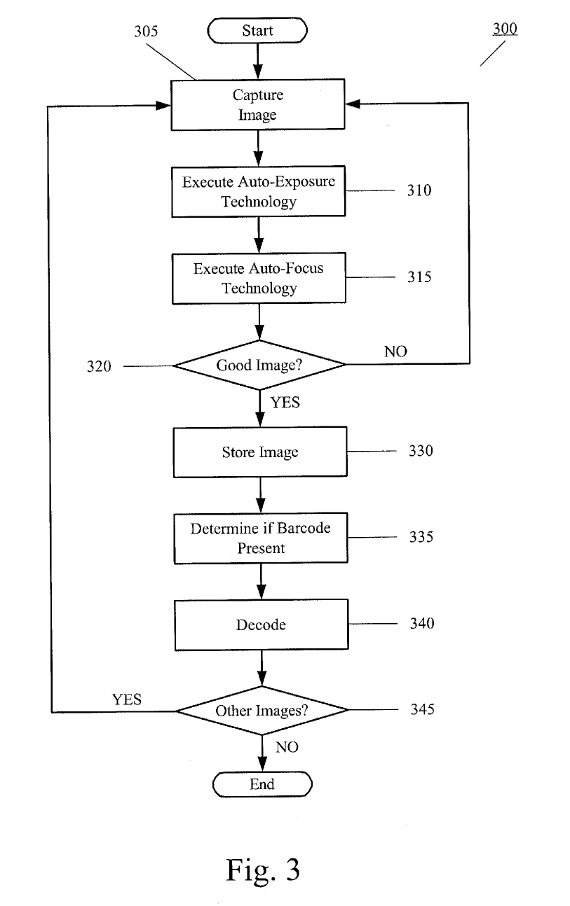

FIG. 3 shows a method 300 for locating a barcode using image analysis according to an exemplary embodiment of the present invention. As discussed above, the image analysis according to the exemplary embodiments of the present invention include the auto-focus algorithm and the auto-exposure algorithm. The method 300 will be described with reference to the MU 100 of FIG. 1 and the image 200 of FIG. 2.

In step 305, the image 200 is captured. The camera 120 may perform the processing to acquire the appropriate image. Specifically, as illustrated in steps 310 and 315, the auto-exposure technology and the auto-focus technology are executed, respectively.

As discussed above, the auto-exposure technology may be run by the processor 105 to determine the appropriate image to be captured. Specifically, the auto-exposure technology may be run on the noted locations 205-215 on the image 200. The auto-exposure technology may continuously adjust the exposure of the locations 205-215 until those sections of the image 200 have adequate contrast for further analysis. With reference to monochromatic images, the auto-exposure technology may adjust for optimal shade balance. It should be noted that the auto-exposure technology may only look at brightness in the image 200. However, in other embodiments, colors of the image 200 may also be considered.

As discussed above, the auto-focus technology may also be run by the processor 105 to determine the appropriate image to be captured. The auto-focus technology may detect high-contrast edges. Thus, with one- or two-dimensional barcodes, the high-contrast between the white and black colors may be detected. With color barcodes, the high contrast between adjacent colors may be detected. These areas may be noted using the auto-focus technology. For example, the locations 205-215 are noted in the image 200.

In step 320, a determination is made whether the image 200 is appropriate. Specifically, the camera 120 continuously processes the image 200 until the auto-exposure technology and the auto-focus technology indicate that the image 200 has optimal shade balance, predefined clarity, etc. If step 320 determines that the image is not appropriate, the method 300 returns to step 305 where the image is captured again and further processed using the auto-exposure technology and the auto-focus technology until an appropriate image is found. If step 320 determines that the image is appropriate, the method 300 continues to step 330 where the image is stored for further analysis.

It should be noted that the storing of the image 200 may be done in a variety of ways. As discussed above, in a first exemplary embodiment, the image 200 may be captured using the camera 120. In a second exemplary embodiment, the image 200 may be acquired from a data acquisition device. The data acquisition device may transmit (e.g., through a network) to a device that processes the image 200. As discussed above, data relating to the image 200 may also include data generated while capturing the image 200 such as data from running the auto-exposure technology and/or the auto-focus technology. This data may also be stored. It should also be noted that the image 200 may be a color image or a monochromatic image. The image 200 may be captured as a monochromatic image when locating a barcode that is one-dimensional or two-dimensional. That is, the one-dimensional or two-dimensional barcode is often depicted using only black and white. The image 200 may be captured as a color image when locating a barcode that is a color barcode. The color barcode may include a variety of different colors in a predetermined pattern.

In step 335, a determination is made whether any of the locations include a barcode. As discussed above, the data produced by the auto-focus algorithm and the auto-exposure algorithm may be used to narrow a search field in which to determine the locations of the barcode. That is, upon ascertaining the locations 205-215, the determination may be made. When a location includes a barcode, the method 300 continues to step 340 where the barcode is decoded.

In step 345, a determination is made if other images are to be analyzed. That is, a packaging box may include barcodes on other sides than the side in which the image 200 is captured. If other images are to be analyzed, the method 300 returns to step 305 where the image is re-captured. When all images are analyzed, the method 300 ends.

The method 300 may include further steps so that a more efficient locating of barcodes may be performed. For example, a ranking arrangement may be used. The ranking arrangement may use the data from the auto-focus algorithm. Specifically, locations including higher contrast edges may take precedence over locations including lower contrast edges. In another example, the method 300 may include steps when no barcode is located in the captured image. When the method 300 determines that no barcode exists, an error message may be displayed, a “no barcode exists” message may be displayed, a sound may be played, etc.

Those skilled in the art will understand that the above described exemplary embodiments may be implemented in any number of manners, including, as a separate software module, as a combination of hardware and software, etc. For example, the auto-focus and auto-exposure algorithms may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a memory storing an image, the image including a plurality of areas, the image captured using at least one of an auto-exposure technology and an auto-focus technology; and
a processor coupled to the memory and selecting at least one of the plurality of areas as a function of predetermined data, the data being related to the at least one of the auto-exposure technology and the auto-focus technology, the processor locating a symbol in the at least one selected areas.

2. The device of claim 1, wherein the symbol is one of a barcode and an optical character recognition string.

3. The device of claim 2, wherein, when the barcode is one of a one-dimensional barcode and a two-dimensional barcode, the image is a monochromatic image.

4. The device of claim 3, wherein, when the barcode is one of a one-dimensional barcode and a two-dimensional barcode, the contrast edges includes a change from a black area to a white area of one of the one-dimensional barcode and the two-dimensional barcode.

5. The device of claim 2, wherein, when the barcode is a color barcode, the image is a color image.

6. The device of claim 5, wherein, when the barcode is a color barcode, the contrast edges includes a change from a first color to a second color adjacent to the first color of the color barcode.

7. The device of claim 1, further comprising:
a data acquisition module capturing the image.

8. The device of claim 1, wherein the selected ones of the plurality of areas are ranked in a list, the list indicating an order for the processor to locate the symbol in the selected ones as a function of the contrast edges.

9. The device of claim 1, wherein the image is of a first side of a packaging box.

10. The device of claim 9, wherein at least one further image is captured, the processor locating a further symbol on the at least one further image, the at least one further image being of at least a second side of the packaging box.

11. A method, comprising:
acquiring an image using at least one of an auto-exposure technology and an auto-focus technology, the image including a plurality of areas;
selecting at least one of the plurality of areas as a function of data relating to the at least one of the auto-exposure technology and the auto-focus technology; and
locating a symbol within the at least one selected areas.

12. The method of claim 11, wherein the symbol is one of a barcode and an optical character recognition string.

13. The method of claim 12, wherein, when the barcode is one of a one-dimensional barcode and a two-dimensional barcode, the image is a monochromatic image.

14. The method of claim 13, wherein, when the barcode is one of a one-dimensional barcode and a two-dimensional barcode, the contrast edges includes a change from a black area to a white area of one of the one-dimensional barcode and the two-dimensional barcode.

15. The method of claim 12, wherein, when the barcode is a color barcode, the image is a color image.

16. The method of claim 15, wherein, when the barcode is a color barcode, the contrast edges includes a change from a first color to a second color adjacent to the first color of the color barcode.

17. The method of claim 16, wherein the image is acquired using a data acquisition device.

18. The method of claim 11, further comprising:
ranking the selected ones of the plurality of areas in a list, the list indicating an order to locate the symbol in the selected ones as a function of the contrast edges.

19. The method of claim 11, wherein the image is of a first side of a packaging box.

20. The method of claim 19, further comprising:
capturing at least one further image to locate a further symbol on the at least one further image, the at least one further image being of at least a second side of the packaging box.

21. A device, comprising:
a storage means for storing an image, the image including a plurality of areas, the image being captured using at least one of an auto-exposure technology and an auto-focus technology; and
a processing means coupled to the storage means for selecting at least one of the plurality of areas as a function of predetermined data, the data being related to the at least one of the auto-exposure technology and the auto-focus technology, the processing means locating a symbol in the at least one selected areas.

22. A computer readable storage medium including a set of instructions executable by a processor, the set of instructions operable to:
acquire an image using at least one of an auto-exposure technology and an auto-focus technology, the image including a plurality of areas;
select at least one of the plurality of areas as a function of data relating to the at least one of the auto-exposure technology and the auto-focus technology; and
locate a symbol within the at least one selected areas.
